(19) United States
(12) Patent Application Publication
(10) Pub. No.: US 2019/0120194 A1
(43) Pub. Date: Apr. 25, 2019

(54) START-UP METHOD OF AN INTERNAL COMBUSTION ENGINE WITH THE AID OF A BELT-DRIVEN STARTER GENERATOR

(71) Applicants: Robert Bosch GmbH, Stuttgart (DE); SEG AUTOMOTIVE GERMANY GMBH, Stuttgart (DE)

(72) Inventors: Julian Roesner, Untergruppenbach (DE); Martin Henger, Tamm (DE)

(21) Appl. No.: 16/095,460

(22) PCT Filed: Mar. 30, 2017
(86) PCT No.: PCT/EP2017/057539

§ 371 Date: Oct. 22, 2018

(30) Foreign Application Priority Data
May 23, 2016 (DE) 10 2016 208 901.3

(51) Int. Cl. F02N 11/04; F02N 15/08; F02N 11/08; H02P 9/08

(52) U.S. Cl. CPC F02N 11/04; F02N 15/08; F02N 11/0859; F16H 7/02; F02N 2011/0896; F02N 2300/104; F02N 2300/106; H02P 9/08

(57) ABSTRACT

A method for improving a start-up of an internal combustion engine with the aid of a belt-driven starter generator which includes a stator winding and a rotor winding, the starter generator for generating a start-up torque being operated in such a way that the stator winding and the rotor winding are energized essentially at the same time immediately after a start-up request of the starter generator. Also described is a processing unit to perform the method and a computer readable medium.

### FIELD OF THE INVENTION

The present invention relates to a method for improving a start-up of an internal combustion machine, in particular of a combustion engine, with the aid of a belt-driven starter generator, as well as to a processing unit for carrying out this method.

### BACKGROUND INFORMATION

Electric machines may be used in motor vehicles as so-called starter generators in order to, on the one hand, start an internal combustion engine during motor operation of the electric machine and, on the other hand, to generate power for the vehicle electrical system and to charge the battery of the motor vehicle during generator operation of the electric machine. Starter generators may be connected to the internal combustion engine or the crankshaft via a belt drive.

Separately excited electric machines, in particular three-phase synchronous machines, are, in particular, suitable for use as belt-driven starter generators (BSGs), since their motoring torque is controllable particularly well. A desirable torque may be set by correspondingly controlling the rotor winding (field coil) and/or the stator winding (three or five stator phases are common, for example). A torque modulation over time may be used in order to achieve a low-noise and low-vibration start-up.

In order to reduce slip during belt drive, belt tensioners, such as so-called reciprocating tensioning systems, may be used.

Tensioning the belt, however, proves to be difficult as a result of the tight alternating span and slack span during motor operation and generator operation. In particular, jerks, vibrations, and noises may occur during the start-up of the internal combustion engine due to a BSG.

A method for smoothly cranking an internal combustion engine with the aid of a belt-driven starter generator, whose rotor windings are pre-excited prior to a start-up request with the aid of an excitation current, is known from DE 10 2012 203374 A1. In order to build up the torque necessary for the start-up of an internal combustion engine, the stator windings for supplying the rotor with current are energized with a time delay.

Based on the approaches from the related art, a target conflict generally arises, since although a smooth cranking of the internal combustion engine may be made possible by a pre-excitation of the electric machine, the latency between the start-up request and the buildup of a torque necessary for starting up an internal combustion engine is increased, however.

### SUMMARY OF THE INVENTION

According to the present invention, a method for improving a start-up of an internal combustion machine, in particular of a combustion engine, with the aid of a belt-driven starter generator having the features described herein as well as a processing unit for carrying out this method is provided. Advantageous embodiments are the subject matter of the further descriptions herein as well as of the following description.

The present invention provides for an operation of a starter generator for generating a start-up torque in such a way that the stator winding and the rotor winding are energized essentially at the same time immediately after a start-up request of the starter generator. In this way, it may be achieved that the internal combustion engine is cranked with the aid of the electric machine without any corresponding delay, for example due to awaiting a latency which is effectuated by a pre-excitation of the rotor winding. A corresponding latency or down time which elapses between a start-up request and the start-up of the internal combustion engine without bringing about a torque and which is considered to be bothersome by the driver of a vehicle, in which the corresponding internal combustion engine may be accommodated, may be avoided in this way.

In another specific embodiment of the present invention, a setpoint torque is predefined for a torque buildup by the starter generator and the stator winding and the rotor winding are energized in such a way that the gradient of the torque increase monotonically increases directly after a start-up request and until the setpoint torque is reached. It may be achieved with the aid of a measure of this type that the internal combustion engine is cranked directly following a start-up request. The monotonic progression of the torque increase additionally ensures that a smooth cranking of the internal combustion engine is ensured and that the internal combustion engine is cranked by the electric machine without any corresponding down time. An effect of this type is in particular provided in combination with the previously mentioned specific embodiment.

In another specific embodiment of the present invention, the gradient of the torque increase is always kept in a band whose upper limit is approximately 2,000 Nm/s and whose lower limit is approximately 300 Nm/s. The torque increase may be approximately 1,000 Nm/s, further approximately 330 Nm/s. The present invention is based on the finding that in the case of torque gradients which are greater than 2,000 Nm/s, overshoots are possible up to a chaotic dynamic excitation of the components coupled to the internal combustion engine with the aid of the belt or of a belt tensioner. The torque gradients are thus selected in such a way that a chaotic excitation of exactly this type is prevented in the case of a rapid and potentially smooth start of the internal combustion engine.

In another specific embodiment of the present invention, the stator winding and the rotor winding are energized in such a way that the gradient resulting from a linear approximation of the torque increase is always smaller than the upper limit of the torque increase. In principle, the torque increase may run linearly, in particular in the shape of a ramp. However, a nonlinear progression of the torque increase is also possible. A nonlinear progression may be advantageous in particular when a desired start-up request of the internal combustion engine is to be implemented even more rapidly. In addition, a measure of this type may reduce the phase current stress or the thermal stress of the stator winding. In this case, it must be kept in mind, however, that over the time duration of a start-up the regression line resulting within a linear approximation has a gradient which is smaller than the upper limit of the torque increase which is approximately 2,000 Nm/s. To achieve this, the stator winding and the rotor winding may be energized in such a way that the predefined setpoint torque is achieved after approximately 30 ms at the earliest.

In another specific embodiment of the present invention, the stator winding and the rotor winding are energized in such a way that the current flowing through the stator winding is below a threshold value and the gradual increase of the excitation current through the rotor winding monotonically increases directly after a start-up request and up until reaching the setpoint torque. Here, it may be particularly provided that a pulse-width modulated supply voltage is applied to the stator winding for the energization. By selecting a pulse-width modulated supply voltage, amplitude and phase position of the phase voltage may be easily established. The excitation current buildup should in general take place as quickly as possible, but in practice, it is considerably slower than the phase current buildup due to the high time constant of the rotor winding. In principle, the phase current as well as the excitation current are, however, freely controllable to the greatest possible extent within a large bandwidth, which is why both control variables are available in principle for the purpose of adjusting a corresponding torque gradient.

A processing unit according to the present invention, for example a control unit of a motor vehicle, is configured to carry out a method according to the present invention, in particular from a programming point of view. Here, a computer program for implementing the method from a programming point of view may be stored on a data carrier, in particular a memory.

It is also advantageous to implement the method in the form of software, since this is particularly cost-effective, in particular when an executing control unit is used for other tasks and is thus present anyway. Suitable data carriers for providing the computer program are, in particular, floppy disks, hard drives, flash memories, EEPROMs, CD-ROMs, DVDs, and many others. It is also possible to download a program via computer networks (Internet, Intranet, etc.).

Further advantages and embodiments of the present invention result from the description and the appended drawing.

The present invention is schematically illustrated in the drawing on the basis of one exemplary embodiment and is described in greater detail below with reference to the drawing.

### BRIEF DESCRIPTION OF THE DRAWINGS

FIG. 1 schematically shows a system including an internal combustion engine, a belt-driven starter generator, and a vehicle electrical system, such as the one on which the present invention may be based.

FIG. 2 shows one specific embodiment of a starter generator including a current converter and controllable switching elements, such as the one on which the present invention may be based.

FIG. 3 shows a schematic equivalent circuit diagram of a separately excited one-phase synchronous machine.

FIG. 4 shows an illustration of input and output variables effectuated by a method for switching on an electric machine according to the related art.

FIG. 5a shows an illustration of input and output variables effectuated by a method according to the present invention for switching on an electric machine according to a first exemplary embodiment.

FIG. 5b shows an illustration of input and output variables effectuated by a method according to the present invention for switching on an electric machine according to another exemplary embodiment.

FIG. 6 shows a parameter study of a dynamic behavior, effectuated by a primary excitation, of an elastically coupled system to masses.

### DETAILED DESCRIPTION

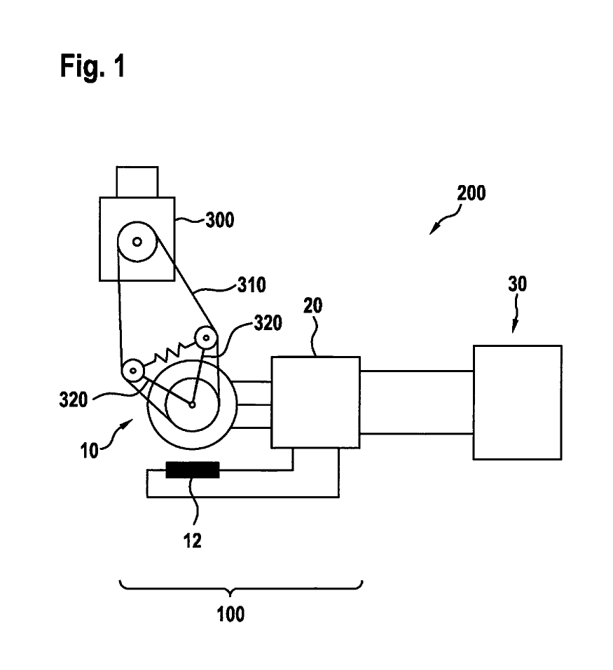

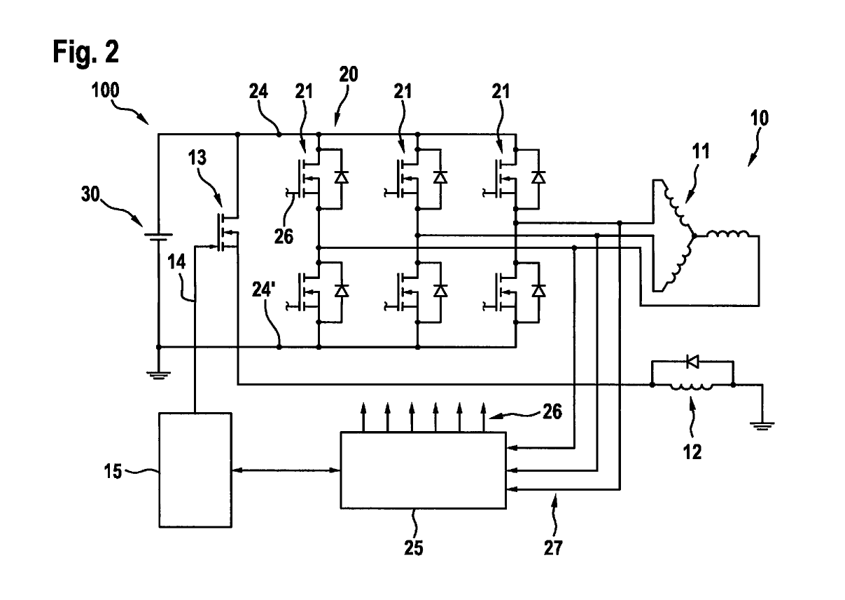

The present invention is based on a system illustrated in FIGS. 1 and 2, in which identical elements are provided with identical reference numerals.

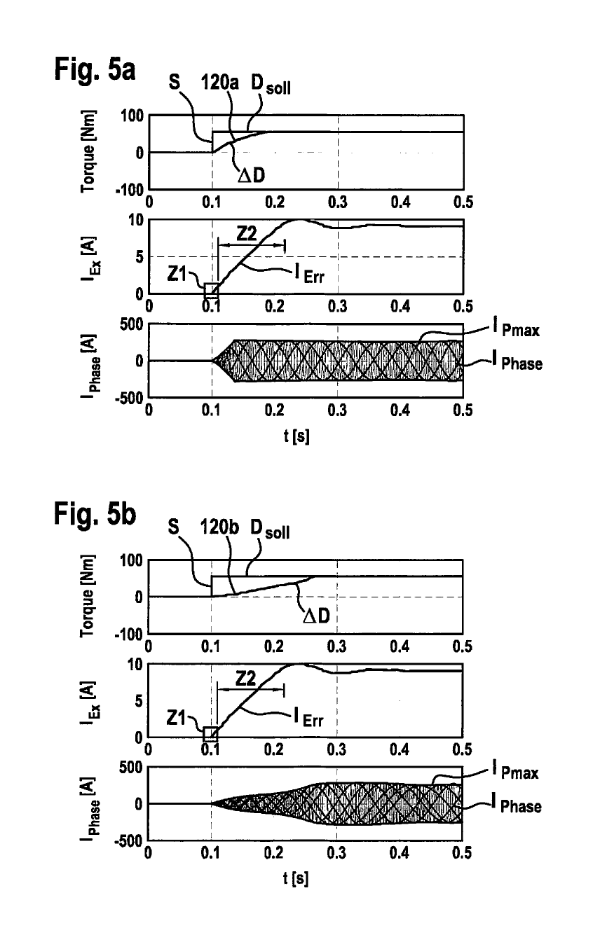

In FIG. 1, a system 200 including an internal combustion engine 300, a belt-driven starter generator 100 as the electric machine, and a vehicle electrical system 30 is illustrated, based on which the specific embodiments (cf. FIG. 5 in particular) of the present invention are elucidated.

Internal combustion engine 300 is connected to starter generator 100 via a belt 310, a belt tensioner being provided which is configured as a reciprocating belt tensioning system 320 and which is capable of tensioning belt 310 during operation independently of the torque direction. Belt 310 thus represents an elastic coupling between starter generator 100, the crankshaft of internal combustion engine 300, and possible other components, for example an air-conditioning compressor for an air conditioning system (not illustrated).

In FIG. 2, starter generator 100 is schematically shown in the form of a circuit diagram. The starter generator includes a generator component 10 and a current converter component 20. The current converter component is usually operated as a rectifier during the generator operation of the machine and as an inverter during the motor operation.

Generator component 10 is illustrated only schematically in the form of stator windings 11 which are interconnected in a star-shaped manner and in the form of an excitation or rotor winding 12 which is connected in parallel to a diode. The rotor winding is switched in a clocked manner with the aid of a power switch 13 which is connected to a terminal 24 of current converter component 20. The activation of power switch 13 takes place via an activation line 14 according to a field controller 15, power switch 13 being generally integrated into an application-specific integrated circuit (ASIC) of the field controller similarly to the diode which is connected in parallel to rotor winding 12. The excitation current may be set via a pulse-width modulated voltage signal.

Within the scope of the present application, a three-phase generator is illustrated. In principle, the present invention is, however, also applicable in the case of generators having fewer or more phases, e.g., five-phase generators.

Current converter component 20 is implemented in this case as a B6 circuit and includes switching elements 21 which may be implemented as MOSFETs 21, for example. MOSFETs 21 are, for example, connected via busbars to particular stator windings 11 of the generator. Furthermore, the MOSFETs are connected to terminals 24, 24′ and make available a direct current for a vehicle electrical system 30 including the battery of a motor vehicle if accordingly activated. The activation of switching elements 21 takes place with the aid of an activation device 25 via activation channels 26, not all of which being provided with reference numerals for the sake of clarity. Activation device 25 receives the phase voltage of the individual stator windings via phase channels 27 in each case. In order to provide these phase voltages, additional devices may be provided which are, however, not illustrated for the sake of clarity.

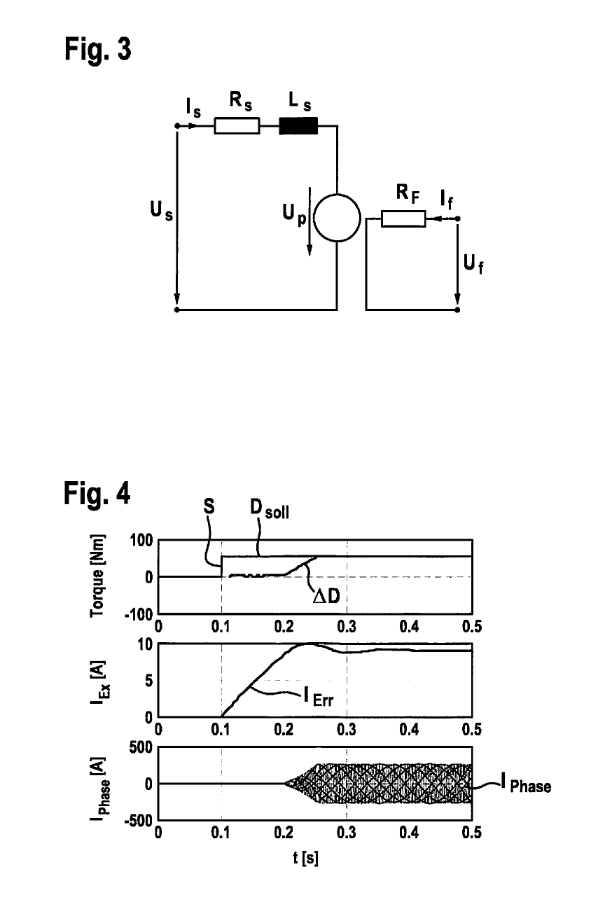

During motor operation, starter generator 100 is used to start up internal combustion engine 300. Here, current converter component 20 is operated according to one embodiment of the present invention, as described in the following by way of example of a separately excited one-phase synchronous machine (cf. FIG. 3). The starter generator is supplied with power by the battery.

FIG. 3 shows an equivalent circuit diagram of a separately excited one-phase synchronous machine. To generate a torque, excitation current I_{Err} is generated in the rotor winding (field winding) through voltage U_{f} taking into consideration resistance R_{F}. This excitation current I_{Err} induces synchronous generated voltage Uₚ in the stator winding 11 when electric machine 100 is rotating. Phase voltage Uₛ generated by inverter 20 is applied to the terminals of phase winding 11 (cf. FIG. 2). Amplitude and phase position of voltage Uₛ are set with the aid of pulse-width modulation (PWM). This voltage Uₛ generates corresponding phase current I_{Phase} in phase winding 11 taking into consideration resistance Rₛ and inductance Lₛ. To generate a torque, excitation current I_{Err} as well as phase current I_{Phase} are required, both being switched on immediately after a start-up request S of an internal combustion engine 300 according to the present invention and increased in such a way that the time necessary for starting up internal combustion engine 300 may be kept short.

In FIG. 4, the chronological progressions of torque, excitation current I_{Ex}, and phase current are illustrated which result in the case of an application of a method known from the related art for initiating a start-up of an internal combustion engine 300 with the aid of a belt-driven starter generator 100. At point in time t=0.1 s, a start-up request S takes place and a torque Dₛₑₜₚₒᵢₙₜ of 50 Nm is requested. Thereafter, excitation current I_{Ex} is initially switched on. At point in time t=0.2 s, the excitation current has reached its setpoint value and the phase currents are switched on with a time delay. Phase currents I_{Phase} are controlled with the aid of the field-oriented control in such a way that a torque progression ΔD results in the shape of a ramp having slope 1,000 Nm/s. Due to the energization of stator winding 11 and rotor winding 12 falling apart over time, there is a latency in which no torque is transferred from electric machine 100 to internal combustion engine 300. Accordingly, the overall time of a start-up is also slowed down due to a belt-driven starter generator 100 activated in this manner.

In FIGS. 5a and 5b, the chronological progressions of torque 120a, b, excitation current I_{Err}, and phase current I_{Phase} are illustrated which result in the case of an application of a method according to the present invention for improving a start-up of an internal combustion engine 300 with the aid of a belt-driven starter generator 100. According to the first exemplary embodiment (FIG. 5a), a start-up request S takes place at a point in time t=0.1 s and immediately thereafter, excitation current I_{Err} and phase current I_{Phase} are switched on at the same time. A setpoint torque Dₛₑₜₚₒᵢₙₜ of 50 Nm is predefined and excitation current I_{Err} and phase current I_{Phase} are controlled in such a way that a torque gradient ΔD (slope) 1,000 Nm/s is predefined.

Since phase current I_{Phase} may not exceed a certain maximum value I_{Pmax}, typically 200 amperes, generated torque 120a is smaller than predefined torque Dₛₑₜₚₒᵢₙₜ, as long as desired excitation current I_{Err} has not been reached. In the present case, maximum value I_{Pmax} is provided by the envelope of phase current progression I_{Phase} Excitation current I_{Err} is controlled to a setpoint value, the setpoint value for the excitation current being stored in a look-up table as a function of the setpoint torque and the rotational speed. This setpoint value is set via a PI controller. The torque control takes place via the phase current, the instantaneously measured excitation current being incorporated into the setpoint value computation for the phase currents. The time required to build up the torque necessary for cranking the internal combustion engine is still shortened as compared to the related art—in the case of comparable boundary conditions—from 250 ms (cf. FIGS. 4) to 190 ms.

In addition, stator winding 11 and rotor winding 12 may be energized in such a way that the gradient of torque increase 120a in a first time window Z1, which directly chronologically follows start-up request S, is reduced as compared to the gradient of torque increase 120a in a further time window Z2, which chronologically follows first time window Z1. In this way, the gradient of torque increase 120a is adjusted in such a way that it is possible to crank internal combustion engine 300 with the aid of electric machine 100 not jerkily, but smoothly by a correspondingly adjusted torque progression. In a second time window Z2 directly following first time window Z1, the gradient of torque 120a is correspondingly increased to ensure a rapid start-up of internal combustion engine 300. In this case, the chronological progression of the gradient is configured to be linear, in particular in the shape of a ramp, in the further time window. The flattening of the torque progression in first time window Z1 may be in particular established by the coil inductances, in particular field coil 12, since a retardation in the excitation current start-up results due to the self-inductance of the coil.

The specific embodiment illustrated in FIG. 5b is different from the specific embodiment illustrated in FIG. 5a in that torque gradient ΔD (slope) is only 333 Nm/s. Based on this predefined value, setpoint torque Dₛₑₜₚₒᵢₙₜ of 50 Nm is reached at the same point in time as in the related art (cf. FIG. 4), this takes place, however, at a considerably reduced torque gradient ΔD as compared to the method known from the related art, which has a positive effect on the stress of the belt drive and in addition reduces dynamic overshoots in the overall system of the driven components.

In the two cases described above, a ramp-shaped torque increase may be achieved, the slope of the torque ramp being predefined as a function of the type of operation and the ramps also being different for the two cases described above.

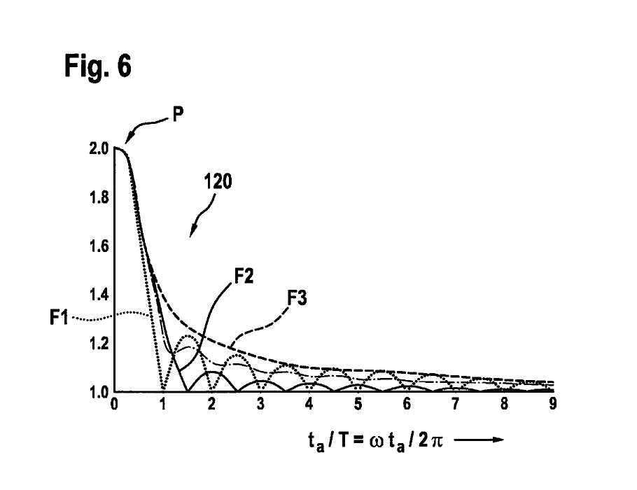

In FIG. 6, a parameter study is illustrated of a dynamic behavior, effectuated by a primary excitation P, of a system of coupled masses, as illustrated in FIG. 1, for example. In the present case, three different forms of an excitation and their effect on an elastically coupled system, as described by way of example in FIG. 1, is discussed. The duration over time of excitation tₐ, which is a measure for the gradient of an excitation (similarly to the slope in the torque progression), was normalized using period duration T, to the oscillation resulting from the excitation. Consequently, the amplitude of the excitation or the amplitude of the oscillation resulting from the excitation is illustrated in FIG. 6 in arbitrary units as well as time tₐ/T which is normalized using the period duration and which corresponds in angular frequencies to ωtₐ/2π.

In first case F1, normalized excitation duration is tₐ/T<=0.2. The gradient of the excitation is therefore great enough for this excitation to be referred to as pulsed. The dynamic of the overall system resulting herefrom is very great, since due to the constant intrinsic damping of the overall system in the present case the amplitude is not attenuated to a minor residual value until after eight oscillation amplitudes. In second case F2, the duration over time of the excitation is in interval 0.2<tₐ/T<=5.0. The excitations occurring in this interval are referred to as chronologically controllable. Here, it is clearly apparent that the resulting amplitudes have almost already completely attenuated after a very short period of time.

A further case F3 describes an excitation in open interval 5.0<tₐ/T. In the case of this excitation duration, the constant intrinsic attenuation of the overall system is great enough compared to the excitation, that the system does not even start oscillating. On the basis of this model, an estimation about a maximally admissible torque gradient was deduced which allows for the torque gradient to be selected exactly great enough that, on the one hand, a rapid cranking of internal combustion engine 300 may be ensured and on the other hand, an excessively dynamic application to the overall system is avoided. The limiting value or the limiting range ascertained by way of this model is approximately at 2,000 Nm/s.

The energization of stator winding 11 may take place during an unclocked (so-called block operation) or a clocked (so-called pulse-width modulated (PWM) operation) pulse-controlled inverter operation. The selected activation pattern may be selected in this case independently of the rotational speed and the desired torque. In the case of the block commutation, the semiconductor switches remain permanently switched on for the time period of a phase activation in contrast to the pulse-width modulated operation. During the pulse-width-modulated operation, the semiconductor switches may be activated at a high frequency (typically between 2 kHz and 20 kHz) using a specific activation pattern, which causes a harmonic progression of the phase current, thus resulting in a reduced torque waviness and an improved efficiency. Both methods are known from the related art.

1-10. (canceled)

11. A method for improving a start-up of an internal combustion engine with a belt-driven starter generator, which includes a stator winding and a rotor winding, the method comprising:
operating the starter generator for generating a start-up torque so that the stator winding and the rotor winding are energized essentially at the same time immediately after a start-up request of the starter generator.

12. The method of claim 11, wherein a setpoint torque is predefined for a torque buildup by the starter generator, and the stator winding and the rotor winding are energized so that a gradient of a torque increase monotonically increases directly after the start-up request and until a setpoint torque is reached.

13. The method of claim 11, wherein a gradient of a torque increase runs in a band having an upper limit of approximately 2,000 Nm/s and a lower limit of approximately 300 Nm/s.

14. The method of claim 12, wherein the stator winding and the rotor winding are energized so that the gradient resulting from a linear approximation of the torque increase is smaller than the upper limit of the torque increase.

15. The method of claim 11, wherein a current flowing through the stator winding is below a threshold value and a gradual increase of an excitation current through the rotor winding monotonically increases directly after a start-up request and up until reaching the setpoint torque.

16. The method of claim 11, wherein a block-commutated and/or pulse-width modulated supply voltage is applied to the stator winding for the energization.

17. The method of claim 11, wherein the torque necessary for starting up the internal combustion engine is effectuated by the belt-driven starter generator.

18. A processing unit, comprising:
a non-transitory computer readable medium having a computer program, which is executable by a processor, including a program code arrangement having program code for improving a start-up of an internal combustion engine with a belt-driven starter generator, which includes a stator winding and a rotor winding, by performing the following:
operating the starter generator for generating a start-up torque so that the stator winding and the rotor winding are energized essentially at the same time immediately after a start-up request of the starter generator.

19. A non-transitory computer readable medium having a computer program, which is executable by a processor, comprising:
a program code arrangement having program code for improving a start-up of an internal combustion engine with a belt-driven starter generator, which includes a stator winding and a rotor winding, by performing the following:
operating the starter generator for generating a start-up torque so that the stator winding and the rotor winding are energized essentially at the same time immediately after a start-up request of the starter generator.

20. The computer readable medium of claim 19, wherein a setpoint torque is predefined for a torque buildup by the starter generator, and the stator winding and the rotor winding are energized so that a gradient of a torque increase monotonically increases directly after the start-up request and until a setpoint torque is reached.

21. The method of claim 11, wherein a gradient of a torque increase runs in a band having an upper limit of approximately 1,000 Nm/s and a lower limit of approximately 330 Nm/s.

22. The method of claim 12, wherein the stator winding and the rotor winding are energized so that the gradient resulting from a linear approximation of the torque increase is smaller than the upper limit of the torque increase, the setpoint torque being reached after approximately 30 ms at the earliest.
